(19) United States
(12) Patent Application Publication
(10) Pub. No.: US 2007/0178009 A1
(43) Pub. Date: Aug. 2, 2007

(54) Analysis element for use in method of testing specimen

(76) Inventors: Yoshiki Sakaino, Asaka-shi (JP); Yoshihiko Abe, Asaka-shi (JP); Yukio Sudo, Asaka-shi (JP)

Correspondence Address: BIRCH STEWART KOLASCH & BIRCH, PO BOX 747, FALLS CHURCH, VA, 22040-0747, US

(21) Appl. No.: 10/592,230

(22) PCT Filed: Mar. 15, 2005
(86) PCT No.: PCT/JP05/05067

§ 371 Date: Sep. 11, 2006

(30) Foreign Application Priority Data
Mar. 18, 2004 (JP) P2004-078210

(51) Int. Cl. G01N 21/00

(52) U.S. Cl. 422/56

(57) ABSTRACT

An analysis element for use in a blood test method enabling easy and simple operations that are performed quickly up to measurement, an analysis element for use in a blood test method that operations up to the measurement for many components can be quickly performed, and that is safe and has a sufficient measurement accuracy thereof, and an analysis element for use in a test method using body fluids and urines of humans and animals, plain water, seawater, soil extract, agricultural products, marine products, processed-food extracts, and liquid for use in scientific research as specimens, are provided, the present invention relates to a multi-component measurement dry analysis element for use in a method for testing a specimen, the method using an area sensor as a detector to obtain a result of measurement according to information represented by 1000 pixels or more per one component, and to perform simultaneous measurements of plural components.

### TECHNICAL FIELD

This invention relates to an analysis element for use in a method of testing a specimen such as blood of humans and other animals. More particularly, this invention relates to an analysis element for use in a test method using body fluids and urines of humans and animals, plain water, seawater, soil extract, agricultural products, marine products, processed-food extracts, and liquid for use in scientific research, as specimens.

### BACKGROUND ART

Hitherto, a method of diagnosing human diseases by using blood, urine or the like has been performed for a long time as a method enabled to simply and easily diagnose human diseases without harming human bodies. Especially, regarding blood, diagnoses of many test items can be performed.

Hitherto, a wet chemistry analysis method has been developed as an analysis method for such tests of many items. This is a method using what is called a solution reagent. Generally, an apparatus for tests of many items, which employs a wet chemistry analysis method, is of a complex configuration, because many reagent solutions corresponding to many items are combined with techniques of handling thereof. Neither the handling of the apparatus nor the process of handling thereof is simple and easy to perform.

To deal with this, a method enabled to simply and easily perform analysis is searched for.

As one such method, what is called a dry chemistry analysis methodusingno solution for analysis, that is, using an analysis element containing a reagent or the like, which is needed for detecting a specific component and which is in a dry condition, has been developed (Non-patent Document 1).

However, in a case where blood is a specimen, usually, neither the wet chemistry method nor the dry chemistry method uses whole blood. After blood cells are removed therefrom, plasma or serum is devoted to analysis. Hitherto, blood cell separation has been conducted by performing a method, which uses a centrifugal force, as a method of removing blood cell components. Thus, a centrifugal separation operation has been necessary. Consequently, there has been a problem that it takes long time to detect the component. To solve this problem, there has been developed an apparatus for separating blood cells by performing a method using a filter (Patent Document 1). Thus, time required to separate blood cells has been shortened. However, the blood cell separation is an operation differing from the detection. Thus, the shortening of the time is not necessarily sufficient.

To solve this drawback, there have been apparatuses enabled to eliminate the necessity for an operation of separating blood cells by using the dry chemistry analysis method and by being combined with a centrifuge, and also enabled to achieve analysis of many items (Patent Document 2 and Patent Document 3). However, these apparatuses need to operate the centrifuge. Thus, these apparatuses do not successfully satisfy necessary convenience. Further, these apparatuses have a problem that the time required to detect the component is long.

Meanwhile, in an aging society, a blood test enabled to readily measure health conditions has become increasingly important. Regarding lifestyle-related diseases, such a blood test is a means enabled to easily know change in a disease state. Because it is necessary to perform time-lapse observation of the health conditions of aged persons/the progress of the lifestyle-related disease, situations requiring blood tests are increased. Thus, a method, which enables not only healthcare professionals but patients themselves to perform blood sampling and to easily and quickly perform analysis of a blood sample, is desired. Also, in recent years, hospital infection has become a major social issue. Especially, protection against transmission through blood is demanded.

To satisfy this demand, there has been proposed an analyzer integrating all means from a blood sampling tool to an analytical tool by combining the blood sampling using a needle, the blood-cell separation by means of filtration and centrifugation, and the wet chemistry analysis method based on an electrode method with one another (Patent Document 4). However, this analyzer does not successfully satisfy necessary convenience of operation. Further, because variation in measured values may occur, this analyzer does not satisfy necessary accuracy of measurement in clinical examination.

Furthermore, in a healthcare field, it is demanded to more quickly perform operations of taking and analyzing a specimen, and detecting components. Thus, there has been an analyzer integrating all means from a blood sampling tool to an analytical tool in such a way as to be combined with a photodetector (Patent Document 5).

[Patent Document 1] JP-A-2000-180444.

[Patent Document 2] JP-A-2001-512826.

[Patent Document 3] JP-A-2002-514755.

[Patent Document 4] JP-A-2001-258868.

[Patent Document 5] JP-A-2003-287533.

[Nonpatent Document 1] Yuzo Iwata: “11. Another Analysis Method (1) Dry Chemistry”, Clinical Chemistry Practice Manual, Extra Number of Inspection and Technique, Vol. 21, No. 5, pp. 328 to 333, published by Igaku Shoin, 1993.

### DISCLOSURE OF THE INVENTION

As described above, it is demanded that a method of performing tests on a specimen for many items has good operability and is easily and simply performed. Additionally, it is necessary that when used in clinical examination, this method is safe and has sufficient measurement accuracy. Moreover, there has been a demand for a test method enabled to more quickly perform operations up to detection for a larger number of items, as compared with the conventional method.

An object of the invention is to provide an analysis element for use in a blood test method enabled so that operations are easy and simple to perform, and that the operations are performed quickly up to the detection of a component.

Another object of the invention is to provide an analysis element for use in a blood test method enabled so that operations up to the detection of a component are quickly performed for many items, and that the blood test method is safe and has the measurement accuracy thereof is sufficient.

Still another object of the invention is to provide an analysis element for use in a test method using body fluids and urines of humans and animals, and also using plain water, seawater, soil extract, agricultural products, marine products, processed-food extracts, and liquid for use in scientific research as specimens.

As a result of intensive studies, the present inventors have found that the foregoing objects can be achieved by using the combination of a multi-component measurement dry analysis element and a specific detector under specific conditions.

That is, the invention achieves the foregoing objects by the following constitutions.

1. A multi-component measurement dry analysis element for use in a method for testing a specimen, the method using an area sensor as a detector to obtain a result of measurement according to information of 1000 pixels or more per one component and to perform simultaneous measurements of plural components.

2. The multi-component measurement dry analysis element according to the item 1, which comprises a flow channel, a color-developing reactive reagent and a portion supporting said color-developing reactive reagent,

wherein at least one of a width, a depth, and a length of the flow channel is not less than 1 mm, and

wherein a width of the portion supporting the color-developing reactive reagent is not less than twice the width of the flow channel, and/or, a length of the portion supporting the color-developing reactive reagent is not less than 0.4 times the length of the flow channel.

3. The multi-component measurement dry analysis element according to the item 2, which comprises a filtering portion containing a water-insoluble substance that has an equivalent circle diameter of not more than 5 μm and a length equal to or longer than an equivalent circle radius.

4. The multi-component measurement dry analysis element according to the item 2, which comprises a filtering portion containing fibers having an equivalent circle diameter of not more than 5 μm.

5. The multi-component measurement dry analysis element according to the item 2, which comprises a filtering portion containing: fibers having an equivalent circle diameters of not more than 5 μm; and a porous membrane.

6. The multi-component measurement dry analysis element according to the item 2, which comprises a filtering portion containing: glass fibers having an equivalent circle diameters of not more than 5 μm; and a porous membrane.

7. The multi-component measurement dry analysis element according to any one of the items 2 to 6, which comprises a dry multilayer film as a reagent layer in the portion supporting the color-developing reactive reagent.

8. The multi-component measurement dry analysis element according to the item 2 or 3, which comprises a dry multilayer film, to which a porous membrane is adhered, as a reagent layer in the portion supporting the color-developing reactive reagent.

9. The multi-component measurement dry analysis element according to the item 2 or 3, which comprise a dry multilayer film, to which fine particles having a diameter of not more than 100 μm, are adhered, as a reagent layer in the portion supporting the color-developing reactive reagent.

10. The multi-component measurement dry analysis element according to the item 2 or 3, wherein the portion supporting the color-developing reactive reagent is a cell connected to the flow channel.

11. The multi-component measurement dry analysis element according to the item 2 or 3, which comprises a dry multilayer film as a reagent layer of the portion supporting the color-developing reactive reagent, wherein a specimen is supplied to a reagent through a polymer porous element.

12. The multi-component measurement dry analysis element according to the item 2 or 3, which comprises a dry multilayer film as a reagent layer of the portion supporting the color-developing reactive reagent, wherein a specimen is supplied to a reagent through a space formed by engraving the flow channel itself.

13. A multi-component measurement dry analysis element for use in a method for testing a specimen, the method using a line sensor as a detector to perform simultaneous measurements of plural components, wherein the multi-component measurement dry analysis element comprises: a flow channel; a color-developing reactive reagent; a portion supporting the color-developing reactive reagent; and a filtering portion containing a water-insoluble substance that has an equivalent circle diameter of not more than 5 μm and a length equal to or longer than an equivalent circle radius,

wherein at least one of a width, a depth and a length of the flow channel is not less than 1 mm, and

wherein a width of the portion supporting the color-developing reactive reagent is not less than twice the width of said flow channel, and/or, a length of the portion supporting the color-developing reactive reagent is not less than 0.4 times the length of the flow channel.

14. A multi-component measurement dry analysis element for use in a method for testing a specimen, the method using an electrochemical sensor as a detector to perform simultaneous measurements of plural components, wherein the multi-component measurement dry analysis element comprises: a flow channel; a reactive reagent; a portion supporting the reactive reagent; and a filtering portion containing a water-insoluble substance that has an equivalent circle diameter of not more than 5 μm and a length equal to or longer than an equivalent circle radius,

wherein at least one of a width, a depth and a length of the flow channel is not less than 1 mm.

15. A blood collection unit comprising:

the multi-component measurement dry analysis element according to the item 2; and

a blood collecting instrument containing at least two portions capable of sliding from each other while maintaining substantially airtight state,

wherein the blood collecting instrument houses the multi-component measurement dry analysis element, and the at least two portions are slidably combined to form an enclosed space therein capable of being depressurized.

16. The blood collection unit according to the item 15, wherein the blood collecting instrument has a puncture needle having a diameter of not more than 100 μm and having a needle tip angle of not more than 20°.

17. A blood collection unit comprising:

the multi-component measurement dry analysis element according to the item 13; and

a blood collecting instrument containing at least two portions capable of sliding from each other while maintaining substantially airtight state,

wherein the blood collecting instrument houses the multi-component measurement dry analysis element, and the at least two portions are slidably combined to form an enclosed space therein capable of being depressurized.

18. The blood collection unit according to the item 17, wherein the blood collecting instrument has a puncture needle having a diameter of not more than 100 μm and having a needle tip angle of not more than 20°.

19. The multi-component measurement dry analysis element according to the item 2, wherein the specimen is a liquid for use in tests of environment-related materials.

20. The multi-component measurement dry analysis element according to the item 2, wherein the specimen is a liquid for use in tests of agricultural products, marine products, or foods.

21. The multi-component measurement dry analysis element according to the item 2, wherein the specimen is a liquid for use in scientific research.

In short, any one of the following configurations (A), (B), (C) enables the simultaneous detection of many components (items). Thus, tests can be performed on a specimen quickly, more simply and more easily for many components (items).

(A) A multi-component measurement dry analysis element for use in a method for testing a specimen, the method using an area sensor as a detector to obtain a result of measurement according to information of 1000 pixels or more per one component and to perform simultaneous measurements of plural components.

(B) A multi-component measurement dry analysis element for use in a method for testing a specimen, the method using a line sensor as a detector to perform simultaneous measurements of plural components, wherein the multi-component measurement dry analysis element comprises: a flow channel; a color-developing reactive reagent; a portion supporting the color-developing reactive reagent; and a filtering portion containing a water-insoluble substance that has an equivalent circle diameter of not more than 5 μm and a length equal to or longer than an equivalent circle radius,

wherein at least one of a width, a depth and a length of the flow channel is not less than 1 mm, and

wherein a width of the portion supporting the color-developing reactive reagent is not less than twice the width of said flow channel, and/or, a length of the portion supporting the color-developing reactive reagent is not less than 0.4 times the length of the flow channel.

(C) A multi-component measurement dry analysis element for use in a method for testing a specimen, the method using an electrochemical sensor as a detector to perform simultaneous measurements of plural components, wherein the multi-component measurement dry analysis element comprises: a flow channel; a reactive reagent; a portion supporting the reactive reagent; and a filtering portion containing a water-insoluble substance that has an equivalent circle diameter of not more than 5 μm and a length equal to or longer than an equivalent circle radius,

wherein at least one of a width, a depth and a length of the flow channel is not less than 1 mm.

Further, with these configurations, in addition to the attainment of the foregoing objects, it has been found that even when an amount of collected whole blood is large, a sufficient amount of blood plasma can be supplied to a reagent without leakage of red blood cells, and that a multistage reaction between a specimen and a reagent can be performed stepwise.

### BRIEF DESCRIPTION OF THE DRAWINGS

FIG. 1 is a schematic view showing an embodiment of a multi-component measurement dry analysis element.

FIG. 2 is a schematic view showing an embodiment of a multi-component measurement dry analysis element.

FIG. 3 is a schematic view showing an embodiment of a blood collection unit.

FIG. 4 is a schematic view showing an embodiment of a blood collection unit.

FIG. 5 is a schematic view showing an embodiment of a measuring apparatus.

FIG. 6 is a graph showing the relation between a reduced volume under decompression and an amount of collected blood (piston type hard-made vacuum blood collecting tube).

FIG. 7 is a schematic view showing a second example of the embodiment of the multi-component measurement dry analysis element.

FIG. 8 is a photograph showing the second example of the embodiment of the multi-component measurement dry analysis element.

FIG. 9 is a photograph showing the second example of the embodiment of the multi-component measurement dry analysis element in a condition after whole blood is injected.

FIG. 10 is a photograph showing that a color-developing reactive reagent starts developing a color when whole blood was sucked by a thermosyringe after injected in the second example of the embodiment of the multi-component measurement dry analysis element.

FIG. 11 is agraph showing the relationa reflection optical density and an amount of received reflection light.

FIG. 12 is a graph showing how the standard deviation of the reflection optical density (N=10) depended upon a photometric area.

FIG. 13 is a graph showing how the standard deviation of the reflection optical density (N=10) depended upon a photometric area (magnification of lens×1-10 μ/pixel).

FIG. 14 is a scanning electron microscope photograph showing whole blood freeze-dried after dropped onto glassfibers.

### DESCRIPTION OF REFERENCE NUMERALS AND SIGNS

A100 multi-component measurement dry analysis element
A1 flow channel
A2 portion supporting a color-developing reactive reagent
A3 injection hole
A4 top cover
A5 lower member
A6 filter element
A7 color-developing reactive reagent
E1 connecting direction of the top cover
E2 arrow indicating a place at which the filter element is disposed
E3 arrow indicating a place at which the color-developing reactive reagent
B100 blood collecting unit
B1 blood collecting instrument
B2 puncture needle
C1 mounting direction of the multi-component measurement dry analysis element
C2 sliding direction when a pressure is reduced
D whole blood
100 measuring apparatus
1 multi-component measurement dry analysis element setting portion
2 light source
3 light variable portion
4 wavelength variable portion
5a, 5b, 5c lenses
6 area sensor
7 computer
20 multi-component measurement dry analysis element
21 upper member
22 lower member
23 flow channel
24 color-developing
25 tube (injection hole)
26 tube
27 glass fiber filter paper
28 polysulfone porous membrane

### BEST MODE FOR CARRYING OUT THE INVENTION

Hereinafter, as a detector, a multi-component dry analysis element employs an area sensor, a line sensor, or an electrochemical sensor. Thus, first, the detectors are described hereinbelow.

[Detector]

Anything may be used as the area sensor, as long as this thing is arranged in such a manner as to be able to sense light, such as ultraviolet light, visible light, and infrared light, or electromagnetic waves and to obtain two-dimensional information. For instance, a CCD, a MOS, and photographic film are cited as examples of the area sensor. Among these, a CCD is preferable. A result of a measurement relating to one component can be obtained according to information, which is represented by 1000 pixels or more, by detecting the multi-component measurement dry analysis element through the use of the area sensor. Moreover, measurements of plural components are simultaneously achieved.

Anything may be used as the line sensor, as long as this thing is arranged in such a manner as to be able to sense light, such as ultraviolet light, visible light, and infrared light, or electromagnetic waves and to obtain one-dimensional information. For instance, a photodiode array (PDA), and photographic films arranged like grids are cited as examples of the line sensor. Between these, a photodiode array is preferable. Simultaneously, measurements of plural components can be performed by detecting the multi-component measurement dry analysis element through the use of the area sensor. Moreover, measurements of plural components are simultaneously achieved.

Anything may be used as the electrochemical sensor, as long as this can measure an amount of electric current, an electric potential difference, an electric conductivity, and a resistance in an electrically conductive material medium. For instance, electrodes made of a single conductive materials, such as a platinum electrode, a silver electrode, and a carbon electrode, composite electrodes, such as a silver-silver chloride electrode, an enzyme electrode, and a modified electrode coated with an enzyme (such as a glucose oxidase), and the combinations of these electrodes can be cited as examples of the electrochemical sensor. Among these, the modified electrode coated with an enzyme, such as a glucose oxidase, is preferable. Simultaneously, measurements of plural components can be performed by detecting the specific multi-component measurement dry analysis element through the use of the electrochemical sensor.

Next, the multi-component measurement dry analysis element is described in detail. Hereinafter, the case of employing an area sensor as the detector is described. In the cases of employing a line sensor as the detector, and of employing an electrochemical sensor as the detector, the invention can be applied thereto on condition that the multi-component measurement dry analysis element has the configuration (B) or (C), similarly to the case of employing the area sensor as the detector.

[Multi-component Measurement Dry Analysis Element]

The multi-component measurement dry analysis element has a flow channel, a color-developing reactive reagent, and a portion supporting the color-developing reactive reagent. At least one of the width, the depth, and the length of the flow channel is not less than 1 mm. Furthermore, it is preferable that the width of the portion supporting the color-developing reactive reagent is not less than twice the width of the flow channel, and/or that the length of the portion supporting the color-developing reactive reagent is not less than 0.4 times the length of the flow channel.

First, the flow channel is described hereinbelow.

[Flow Channel]

As described above, at least one of the width, the depth, the length of the flow channel is not less than 1 mm, more preferably, ranges from 1 mm to 100 mm. Further, the most preferable range is 1 mm to 30 mm. In a case where at least one of the width, the depth, the length of the flow channel is within this range, a specimen efficiently proceeds in the flow channel, so that this range is preferable.

Any shape of the flow channel can be employed as long as the specimen can pass therethrough. Further, the flow channel may have either only a single path or two branches or more. Also, the flow channel may have any of shapes, such as a linear shape, and a curved-line shape. However, preferably, the flow channel has a linear shape.

Any material may be adopted as the material of the flow channel, as long as a specimen can efficiently pass therethrough. Concretely, resins, such as rubber and plastics, and materials containing silicon can be cited as the material of the flow channel.

Polymethylmethacrylate (PMMA), polycyclic olefin (PCO), polycarbonate (PC), polystyrene (PS), polyethylene (PE), polyethylene terephthalate (PET), polypropylene (PP), polydimethylsiloxane, natural rubber, synthetic rubber, and derivatives thereof are cited as examples of such plastics or rubber.

Glass, quartz, amorphous silicon, such as a silicon wafer, and silicon, such as polymethylsiloxane, are cited as examples of the material containing silicon.

Among these, PMMA, PCO, PS, PC, glass, and a silicon wafer are preferable.

The flow channel can be formed on a solid substrate by utilizing fine processing technology. Examples of a used material are metal, silicon, Teflon™, glass, ceramics, or plastics, or rubber.

PCO, PS, PC, PMMA, PE, PET, and PP are cited as examples of plastics. Natural rubber, synthetic rubber, silicon rubber, and PDMS are cited as examples of rubber.

Glass, quartz, amorphous silicon, such as a silicon wafer, and silicon, such as polymethylsiloxane, are cited as examples of the material containing silicon.

PMMA, PCO, PS, PC, PET, PDMS, glass, and a silicon wafer are cited as particularly preferable examples.

The fine processing technology for making the flow channel is, for example, methods described in “Microreactor—Synthesis Technique for New Era—” (edited by Prof. Junichi Yoshida, Graduate School of Engineering, Kyoto University, published by CMC Publishing Co., Ltd., 2003), and “Application to Photonics, Electronics and Mechatronics”, in Fine Processing Technology, Application Volume (edited by the Meeting Committee of the Society of Polymer Science, Japan, and published by NTS Inc., 2003).

Typical methods are a LIGA technology using X-ray lithography, a high aspect ratio photolithography method using EPON SU-8, a microelectric discharge machining method (μ-EDM), a high aspect ratio machining method by performing a Deep RIE process on silicon, a Hot Emboss machining method, a light shaping method, a laser machining method, an ion-beam machining method, and a mechanical microcutting work method using a microtool made of a hard material, such as diamond. Although these technologies may be singly employed, the combinations thereof may be used. Preferable fine processing technologies are the LIGA technology using X-ray lithography, the high aspect ratio photolithography method using EPON SU-8, the microelectric discharge machining method (μ-EDM), and the mechanical microcutting work method.

The flow channel according to the invention may be formed by using a pattern, which is formed on a silicon wafer by using a photoresist, as a mold, and then pouring a resin thereinto and solidifying the resin (a molding method). Silicon resin typified by PDMS or a derivative thereof can be used in the molding method.

Preferably, the flow channel is surface-treated or surface-modified according to need so that a specimen, especially, whole blood or blood plasma can smoothly pass therethrough. Although methods of surface-treating and surface-modifying vary with the material of the flow channel, existing methods can be utilized. For example, a plasma treatment, a glow treatment, a corona treatment, a method using a surface treatment agent, such as a silane coupling agent, and methods using polyhydroxyethylmethacrylate (PHEMA), polyhydroxyethylacrylate (PMEA), or an acrylic polymer can be cited as examples of the methods of surface-treating and surface-modifying.

The flow channel may be either a part or the entirety of the multi-component measurement dry analysis element. That is, the flow channel may be formed as a part or the entirety of the multi-component measurement dry analysis element by using what is called a microreactor and fine processing technologies usually utilized for micro-analysis elements.

For example, the method described in “Microreactor” (edited by Junichi Yoshida, and published by CMC Publishing Co., Ltd.) can be used as the method for making a microreactor or a micro-analysis element.

Next, the color-developing reactive reagent is described hereinbelow.

“Color-Developing Reactive Reagent”

The color-developing reactive reagent is defined herein as a reagent that is needed for qualitative analysis and quantitative analysis of measured components of a specimen, and that reacts with the measured component of the specimen to perform color-developing or to emit light by the action of light or electricity, or by a chemical reaction, for example, fluorescence and luminescence. According to the invention, the color-developing reactive reagent is appropriately selected according to the kind of a specimen and to the component to measure. Examples of the color-developing reactive reagent are FUJI DRI-CHEM mount slide GLU-P (measurement wavelength: 505 nm, measurement component: glucose) or FUJI DRI-CHEM mount slide TBIL-P (measurement wavelength: 540 nm, measurement component: total bilirubin) manufactured by Fuji Photo Film Co., Ltd. According to the invention, a dry reagent is used as the color-developing reactive reagent which the multi-component measurement dry analysis element has. The dry reagent is a reagent used for what is called the dry chemistry. Any reagent can be used, as long as the reagent can be used for the dry chemistry. Concretely, reagents described in Fuji Film Research & Development, No. 40, p. 83 (published by Fuji Photo Film Co., Ltd., 1995) and in Clinical Pathology, extra edition, special topic No. 106, “Dry Chemistry: New Development of Simple Test” (published by The Clinical Pathology Press, 1997).

In the case that an electrochemical sensor is used as the detector, an enzyme electrode made by mixing a glucose oxidase (GOD), 1,1′-dimethyl-ferrocene, and carbon paste comprising a mixture of graphite powder and paraffin and by then solidifying an obtained mixture is used as a working electrode, instead of the color-developing reactive reagent. A silver-silver chloride electrode is used as a reference electrode. A platinum wire is used as a counter electrode. Thus, an electric-current value, which increases accordingto the concentration of glucose in the specimen, can be measured. A more concrete example of the electrochemical sensor is described by Okuda, Mizutani, Yabuki et al. in the Report of the Hokkaido Industrial Research Institute No. 290, pp. 173-177, 1991.

Next, the portion supporting the color-developing reactive reagent is described hereinbelow.

In the case that an electrochemical sensor is used as the detector, such a portion is similar to the portion of the area sensor, which carries the color-developing reactive reagent, except that such a portion of the electrochemical sensor carries the aforementioned reactive reagent.

“The Portion Supporting the Color-Developing Reactive Reagent”

As described above, preferably, the portion supporting the color-developing reactive reagent is adapted so that the width thereof is not less than twice the width of the flow channel, and/or that the length thereof is not less than 0.4 times the length of the flow channel.

The analysis element may have either only one portion supporting the color-developing reactive reagent or two of such portions or more. Additionally, in the case that the analysis element has two or more of such portions, these portions may be either placed together at one position or arranged separately from one another.

The portion supporting the color-developing reactive reagent may be either connected to the flow channel or incorporated into the flow channel. Further, in the case that such a portion is incorporated into the flow channel, the portion may be a cell. This cell may have any shape, as long as the width/the length thereof satisfies the aforementioned conditions. Materials similar to those described in the description of the flow channel are cited as the material of the cell. Also, the preferable material of the cell is similar to that of the flow channel.

Bonding technology can be used fro connecting the flow channel to the portion supporting the color-developing reactive reagent. Ordinary bonding technologies are roughly classified into a solid-phase bonding technology and a liquid-phase bonding technology. In the case of the solid-phase bonding, usually used typical bonding methods are a pressure-bonding method, and a diffusion-bonding method. In the case of the liquid-phase bonding, usually used typical bonding methods are a welding method, a eutectic bonding method, a soldering method, and an adhesive bonding method.

Furthermore, preferably, the bonding method is highly accurate in such a way as to maintain dimension accuracy without changing the properties of the material due to application of high-temperature heat thereto and without destructing microstructures, such as the flow channel, due to large deformation thereof. Technologies for achieving such a bonding method are silicon direct-bonding, anode-bonding, surface-activation-bonding, direct bonding using a hydrogen bond, bonding using an HF-aqueous solution, Au—Si eutectic bonding, and void-free bonding.

Further, bonding methods using ultrasonic waves or lasers, and bonding method using adhesive agents and adhesive tapes may be used. Alternatively, the connection between the flow channel and the portion may be achieved simply by a pressure.

The portion supporting a color-developing reactive reagent may have any form for supporting the reagent, as long as this portion can carry the color-developing reactive reagent. For instance, a test paper, a disposable electrode, a magnetic material, and a film for analysis are cited as the form thereof. Additionally, in the case of the film, the portion maybe either a single-layered or multilayered.

Preferably, a dry multilayer film is used as a reagent layer in the portion supporting a color-developing reactive reagent. The dry multilayer film is preferable, because all or a part of reagents needed for the qualitative and quantitative analyses of the measured components in the specimen can be incorporated into one or more layers. Films used in the aforementioned dry chemistry are cited as examples of such a dry multilayer film. The films described in Fuji Film Research & Development, No. 40, p. 83 (published by Fuji Photo Film Co., Ltd., 1995) and in Clinical Pathology, extra edition, special topic No. 106, “Dry Chemistry: New Development of Simple Test” (published by The Clinical Pathology Press, 1997) can be cited as concrete examples. A process of performing a multistage reaction stepwise is facilitated by using the dry multilayer film as the reagent layer in the portion supporting the color-developing reactive reagent. Thus, it is preferable to use the dry multilayer film in such a manner. Also, products of the same quality can stably be manufactured. That is, the use of the dry multilayer film in such a manner is preferable, because measurement accuracy needed by a clinical test can be satisfied without necessity for taking variation in quality among lots into consideration.

Furthermore, preferably, a porous membrane is made to adhere to the dry multilayer film. As examples of the porous membrane, cellulose-based porous membranes, such as a nitrocellulose porous membrane, a cellulose acetate porous membrane, a cellulose propionate porous membrane, and a regenerated cellulose porous membrane, and a polysulfone porous membrane, a polyethersulfone porous membrane, a polypropylene porous membrane, a polyethylene porous membrane, and a polyvinylidene chloride porous membrane are cited. More preferable examples of the porous membrane are a polysulfone porous membrane, and a polyethersulfone porous membrane.

Although there are no restrictions put on the method of making the porous membrane adhere to the dry multilayer film, the dry multilayer film is moisturized by using, for example, 15 g to 30 g of water per m² thereof. Then, the porous membrane is pressure-bonded to the dry multilayer film by applying a pressure of 3 kg to 5 kg per cm² at room temperature. Thus, the porous membrane can be made to adhere to the dry multilayer film.

Also, preferably, the dry multilayer film, to which fine particles, whose diameters are not more than 100 μm, are made to adhere, is used as a reagent layer. As examples of the fine particles, inorganic fine particles typified by those made of metal oxide, such as silica, alumina, zirconia, and titania, and organic polymer fine particles typified by polystyrene (PS) fine particles, and polymethylmethacrylate (PMMA) fine particles are cited. More preferably, the fine particles are those made of silica and polystyrene.

Although there are no restrictions put on the method of making the fine particles adhere to the dry multilayer film, for instance, a method of applying an aqueous solution, which is obtained by adding 1% to 10% of polyvinylpyrrolidone (PVP), polyisopropylacrylamide, or a mixture of both thereof to the mass of the fin particles and then drying the solution is cited as an example.

Preferably, depending on the kind of a specimen (to be described later), a filtering portion is used before the specimen is supplied to the portion supporting the color-developing reactive reagent. Any conventional filtering portion and method using the same can be applied thereto. Preferably, filtering materials used in one of the following two portions is used.
(I) A filtering portion containing a water-insoluble substance that has an equivalent circle diameter of not more than 5 μm, and a length that is equal to or longer than an equivalent circle radius.
(II) A filtering portion containing fibers having an equivalent circle diameter of not more than 5 μm.

The use of these portions is preferable, because of the facts that red blood cells can quickly and efficiently be removed from whole blood, especially, in a case where whole blood is used as a specimen, that after red blood cells are removed from whole blood, blood plasma can be supplied to a reagent without activating a special apparatus, and that consequently, time taken to perform operations up to the detection of a component can be shortened.

More preferably, the fibers used in the (II), which has an equivalent circle diameter of not more than 5 μm, are combined with the porous membrane, because of the facts that red blood cells does not leak even when an amount of whole blood is large, and that a sufficient amount of blood plasma can be supplied to a reagent. Still more preferably, the fibers having an equivalent circle diameter of not more than 5 μm, are glass fibers.

Hereinafter, the filter element is described more detailedly.

The “equivalent circle diameter” described herein means what is called an “equivalent diameter”, which is generally used in the technical field of mechanical engineering. Assuming that a circular tube is equivalent to an arbitrarily cross-sectionally shaped pipe (corresponding to the water-insoluble substance, the fiber and the glass fiber described herein above), the diameter of the equivalent circular tube is referred to as an equivalent diameter, and defined as follows:
deq=4A/p
where “deq” designates an equivalent diameter, and “A” denotes a cross-section of the pipe, and “p” represents a wet perimeter length (or circumferential length). When applied to the circular tube, this equivalent diameter is equal to the diameter of the tube. The equivalent diameter is used for estimating the flow property or the heat transfer characteristics of the pipe according to data of the equivalent tube. The equivalent diameter represents a spatial scale (or a representative length) of a phenomenon. In the case of a square pipe, each side of which has a length a, the equivalent diameter thereof is given by:
deq=4a²/4a=a.
In the case of a flow between parallel flat plates having a passage height h, the equivalent diameter thereof is given by:
deq=2h.

The details of these are described in “Mechanical Engineering Dictionary” (edited by the Japan Society of Mechanical Engineers, and published by Maruzen Co., Ltd., 1997).

The equivalent circle radius is calculated, similar to the equivalent circle diameter.

As examples of the water-insoluble substance, silicon, glass, polystyrene (PS), polyethylene terephthalate (PET), poly polycarbonate (PC), polyimide known by trademarks, such as Kevlar™, and glass fibers, glass fiber filter paper, polyethylene terephthalate (PET) fibers, polyimide fibers are cited.

As examples of the fibers, the glass fibers, the glass fiber filter paper, the polyethylene terephthalate (PET) fibers, the polyimide fibers are cited.

Preferably, the diameter of each hole of the porous membrane ranges from 0.2 μm to 30 μm. More preferably, the diameter thereof ranges from 0.3 μm to 8 μm. Still more preferably, the diameter thereof ranges from 0.5μm to 4.5 μm or so. Extremely preferably, the diameter thereof ranges from 0.5 μm to 3 μm.

Further, a porous membrane having a high porosity is preferable. Concretely, preferably, the porosity ranges from about 40% to about 95%. More preferably, the porosity ranges from about 50% to about95%. Still more preferably, the porosity ranges from about 70% to about 95%.

Examples of the porous membrane are a polysulfone film, polyethersulfone film, a fluorine-containing polymer film, a cellulose acetate film, and a nitrocellulose film, which have conventionally be known. Preferable examples thereof are a polysulfone film, and a polyethersulfone film.

Also, a film, whose surface is hydrophilization-treated by using hydrolysis, hydrophilic macromolecules or an activator can be used. A method and compounds, which are usually used when a hydrophilization treatment is performed, can be used as the hydrolysis method, the hydrophilic macromolecules, and the activators, respectively.

A polymer porous element can be used as a filtering portion. That is, the polymer porous element is preferably installed in a flow channel that a specimen is not supplied yet to the portion supporting the color-developing reactive reagent, because the specimen can be supplied to the reagent by removing a solid component unnecessary for the detection, from the specimen.

Examples of the polymer porous element are a polysulfone porous membrane, a polyethersulfone porous membrane, a fluorine-containing polymer porous membrane, a cellulose acetate porous membrane, and a nitrocellulose porous membrane, or porous fine particles, such as polystyrene porous fine particles, and polyvinyl-alcohol-based fine particles. Preferable examples of the polymer porous element are a polysulfone porous membrane, and a polyethersulfone porous membrane.

Furthermore, as the above-mentioned filtering portion, a space can be formed in the flow channel itself by engraving the flow channel, whereby solid components unnecessary for the detection are removed, and a specimen is supplied to a reagent.

An example of an engraving method is a method (that is, a molding method) of using a pattern, which is formed on a silicon wafer by using photoresists), as a mold and of pouring resin thereinto and then solidifying the resin. A shape for removing solid components, which are unnecessary for the detection, is formed in a space of the flow channel by engraving the flow channel to thereby form a space therein. Thus, unnecessary solid components for the detection can be removed. The shape formed by engraving is not limited to a cylindrical one, and may be either a prismatic shape or a semispherical shape. Additionally, preferably, the equivalent circle diameter of the shape formed by engraving is not more than 5 μm. Alternatively, the water-insoluble substance, whose equivalent circle diameter is not more than 5 μm and whose length is equal to or larger than the equivalent circle radius thereof, according to the (I) may be formed in the flow channel by this method.

The aforementioned technology employed as the fine processing technology can be used in the flow channel as the method of engraving the flow channel itself to thereby form the space therein.

In addition, for example, molded materials, which are generally called a “micropillar” and a “nanopillar” and formed into a columnar shape by using a fine processing technology or a processing technology such as μ-TAS, may be disposed at a flow channel before supplying a specimen to the portion supporting the color-developing reactive reagent, and may be used. There are various methods for forming micropillars and nanopillars. A method of exposing and etching a silicon wafer in such a way as to produce a columnar silicon residue may be employed. Alternatively, an imprinting method of using and pressure-attaching a concave mold to a resin and then detaching the mold therefrom to thereby form a projection on the surface of the resin may be used.

Furthermore, the shape is not necessarily limited to a pillar-like shape, and for example, it is sufficient to produce structures each having an equivalent circle diameter of 5 μm or less, by using a photocurable resin and utilizing an optical molding technique. As the shape disposed at a flow channel before supplying a specimen to the portion supporting the color-developing reactive reagent, any shape of the materials used in the water-insoluble substance may be used.

At that time, a plurality of the structures each having an equivalent circle diameter of 5 μm or less are produced, and a structure bridging is produced between the plurality of structures, whereby a mechanical strength is further imparted, and the structures, which meet both necessary filtration performance and mechanical strength requirements, can be produced. Examples of the form of such a structure are a structure bridging between pillars, a structure bridging between fibers, double-cross-like, checkered or honeycomb-like mesh structures, and bridged structures thereof.

Alternatively, the centrifugation maybe used for removing red blood cells from whole blood. In the case of using the centrifugation, the multi-component dry analysis element may have any configuration, as long as the multi-component dry analysis element itself or a part thereof has a configuration enabled to utilize a centrifugal and to separate blood plasma and to lead the separated plasma from the flow channel to the portion supporting the color-developing reactive reagent.

The specimen is injected into the multi-component measurement dry analysis from an injection hole. The specimen may have any shape, as long as the specimen can be injected into the multi-component measurement dry analysis. For example, the flow channel may be connected directly to the outside of the multi-component measurement dry analysis element.

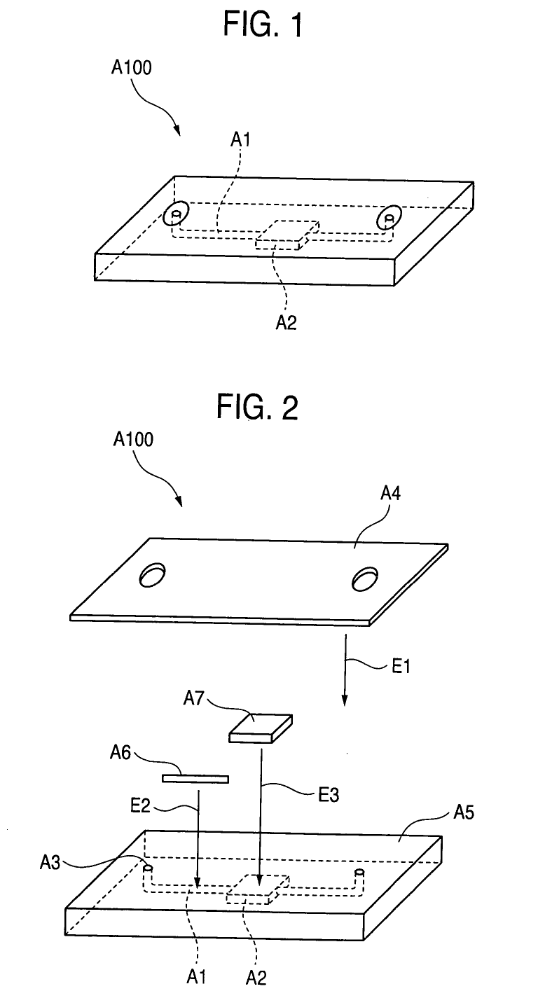

Hereinafter, a preferred embodiment of the multi-component measurement dry analysis element is described by referring to FIGS. 1 and 2. However, the invention is not limited to this embodiment.

A specimen is injected from an injection hole A3 of the multi-component measurement dry analysis element A100. The injected specimen passes through the flow channel A1 and led to a portion A2 supporting a color-developing reactive reagent. As described above, a filter element A6 for applying a filtering portion to a specimen according to the kind thereof can be disposed in the flow channel A1. Alternatively, a polymer porous element can be disposed therein. Alternatively, the flow channel A1 itself can be engraved to thereby form a space. A color-developing reactive reagent A7 is disposed on the portion A2 for supporting the color-developing reactive reagent. As shown in FIG. 2, the constituents A1, A2, and A3 are formed in a lower member A5 by utilizing the fine processing technology. However, as described above, the analysis element may be manufactured by first producing the constituents A1, A2, and A3 and then providing a bottom cover thereon, instead of the lower member A5, and subsequently fabricating the analysis element.

The materials of the multi-component measurement dry analysis element are the same materials of the flow channel. The preferable ranges of dimensions of the multi-component measurement dry analysis element are the same as those of dimensions of the flow channel.

The shape and the size of the multi-component measurement dry analysis element may have any shape and any value, as long as the shape and the size thereof are within ranges enabling a user to easily hold the analysis element in his hand. Concretely, the preferable shape thereof is, for example, a rectangle, and the preferable size thereof is set so that one side of the bottom surface thereof ranges from 10 mm to 50 mm, and that the thickness thereof ranges from 2 mm to 20 mm.

When the multi-component measurement dry analysis element is fabricated, a technology, which is the same as the bonding technology used for connecting the portion, which carries the aforementioned color-developing reactive reagent, to the flow channel, can be used.

Methods for movement of the specimen in the multi-component measurement dry analysis element, that is, from the flow channel to the portion supporting the color-developing reactive reagent are to utilize a pressure, and to utilize a capillary phenomenon. However, it is preferable to utilize a pressure, especially, to utilize a negative pressure.

The multi-component measurement dry analysis element is mounted (housed) in a blood collecting instrument thereby to obtain a blood collecting unit. Hereinafter, the blood collecting unit is described.

[Blood Collecting Unit]

The blood collection unit comprises the multi-component measurement dry analysis element according to claim 2; and a blood collecting instrument containing at least two portions capable of sliding from each other while maintaining substantially airtight state, wherein the blood collecting instrument houses the multi-component measurement dry analysis element, and the at least two portions are slidably combined to form an enclosed space therein capable of being depressurized.

The blood collecting unit may have any shape and any size, as long as in the blood collecting unit, the multi-component measurement dry analysis element is mounted in the blood collecting instrument, the at least two portions are slidably combined with each other while maintaining a substantially airtight condition to form an enclosed space is defined therein capable of being depressurized.

Collected whole blood can be put into the flow channel of the multi-component measurement dry analysis element and also can quickly be led to the portion supporting the color-developing reactive reagent, by forming an enclosed space in the blood collecting unit, which is capable of being depressurized.

The materials of the blood collecting unit are the same materials of the flow channel. The preferable ranges of dimensions of the blood collecting unit are the same as those of dimensions of the flow channel.

When the blood collecting unit is fabricated, a technology, which is the same as the bonding technology used for connecting the portion, which carries the aforementioned color-developing reactive reagent, to the flow channel, can be used.

Preferably, the blood collecting instrument of the blood collecting unit has a puncture needle having a diameter, which is not more than 100 μm, and also having a needle tip, the angle of which is not more than 20°. The puncture needle, which is adapted so that the diameter thereof and the angle of the needle tip thereof are set to be respectively within these ranges, is preferable, because of the facts that the needle can smoothly be stuck and that a patient's pain in blood collection can be alleviated.

The bonding technology used for connecting the portion, which carries the aforementioned color-developing reactive reagent, to the flowchannel, can be used as a method of connecting the blood collecting unit to the puncture needle.

The puncture needle is a hollow one. When blood is collected from a blood vessel, depressurization is performed by making the blood collecting unit to slide, so that whole blood is introduced to the flow channel of the multi-component measurement dry analysis element. For example, an ordinary injection needle may be used as the puncture needle, as long as such a needle satisfies the condition that the diameter thereof and the angle of the needle tip thereof are set to be respectively within the aforementioned ranges. From the view point of micro-blood-collection, a small needle may be used as the puncture needle. Further, it is preferable to mitigate the pain in blood collection by thinning the needle tip. Furthermore, the puncture needle may be produced by utilizing the aforementioned fine processing technology.

The material of the puncture needle is usually metal. Examples thereof are the materials of what is called an injection needle, such as stainless steel, nickel-titanium alloy, and tungsten. Also, the resins, such as plastics, can be used as the material of the multi-component measurement dry analysis element. Concretely, PCO, PS, PC, PMMA, PE, PET, PP, and PDMS are cited as such materials.

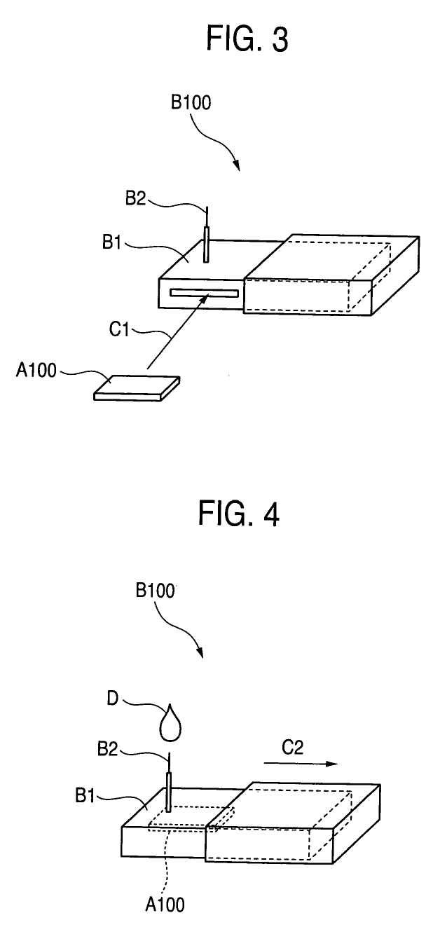

Although a preferred embodiment of the blood collecting unit is described hereinbelow by referring to FIGS. 3 and 4, the invention is not limited thereto.

The multi-component measurement dry analysis element A100 is attached to a blood collecting instrument B1 from a direction C1, so that a blood collecting unit B100 is obtained. After mounted, a puncture needle B2 is stuck into a human, or a horse or the like. Thus, whole blood D is withdrawn. As described above, a part of the blood collecting instrument is slid in a direction C2. Consequently, the inside thereof is depressurized. The withdrawn whole blood D enters the flow channel A1 of the multi-component measurement dry analysis element A100. Then, the whole blood is introduced into a portion A2, which carries a color-developing reactive reagent, and reacts therewith. Upon completion of the reaction, the multi-component measurement dry analysis element A100 is detached from the blood collecting instrument B1, and devoted to the detection of a component. The multi-component measurement dry analysis element A100 may be detached in either the direction C1 that is the same as the direction, in which the element A100 is attached to the instrument B1, from the blood collecting instrument B1 toward the other side of the instrument B1 or a direction opposite to the direction C1, that is, from the side, which is the same as the side to which the element A100 is attached.

Further, in a case where a fingertip, an elbow or a heel is cut by a lancet or the like, and where peripheral blood is taken therefrom and used in a test, the blood collecting instrument of the blood collecting unit does not require the puncture needle. The blood collecting instrument thereof has only to have a hollow structure and to have the function of introducing blood to the analysis element.

[Specimen]

Body fluids and urines of humans and animals, liquid for use in tests of environment-related materials, liquid for use in tests of agricultural products, marine products, foods, and liquid for use in scientific research are cited as specimens provided to the multi-component measurement dry analysis element. Examples of the liquid for use in tests of environment-related materials are plain water, seawater, soil extract. Examples of the liquid for use in tests of agricultural products, marine products, foods are agricultural products and agricultural-product extracts, marine products and marine-product extracts, foods obtained by processing agricultural products and/or marine products, and extracts extracted from the foods obtained by processing agricultural products and/or marine products. Example of the liquid for use in scientific research is liquid for use in studies in chemistry, biology, geoscience, physics, and so on.

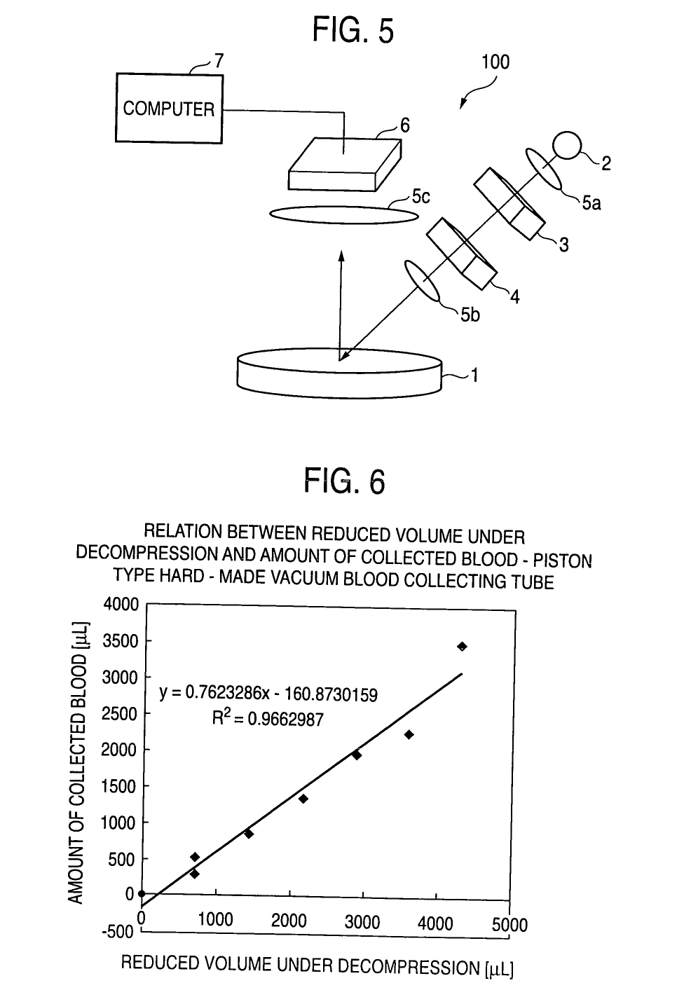

Hereinafter, an outline of the configuration of a measuring apparatus using an area sensor is described by referring to FIG. 5.

A measuring apparatus 100 comprises a multi-component measurement dry analysis element setting portion 1, in which a specimen to be measured is set, and a light source 2 employing a light emitting device, such as a halogen lamp, for irradiating light onto the specimen, a light variable portion 3 for changing the intensity of light irradiated from the light source 2, a wavelength variable portion 4 for changing the wavelength of light irradiated from the light source 2, lenses 5a and 5b for converting light rays irradiated from the light source 2 into parallel light rays and for condensing the light irradiated therefrom, a lens 5c for condensing reflection light reflected from the specimen, an area sensor 6 serving as a light receiving device for receiving the reflection light condensed by the lens 5c, and a computer 7 for controlling each of such portions, for obtaining results of measurements according to the state of the light variable portion 3 and to an amount of light received by the area sensor 6, and for outputting the obtained results to a display or the like. Incidentally, although the computer 7 is adapted to control each of the portions in this embodiment, a computer serving as an integrated controller for controlling each of the portions may be provided separately from the computer 7.

A multi-component measurement dry analysis element is provided in the multi-component measurement dry analysis element setting portion 1. A portion actually devoted to the measurement is a portion (hereunder referred to as the “reagent supporting portion”), which is provided in the multi-component measurement dry analysis element and reacts with the specimen and carries the color-developing reactive reagent.

The light variable portion 3 is adapted to change the intensity of light, which is irradiated onto the specimen from the light source 2, by mechanically putting a perforated or meshed plate member made of metal, such as stainless steel, and an attenuating filter, such as a neutral density filter, in and out of the space provided between the light source 2 and the specimen. In the initial setting thereof, this attenuating filter is inserted therebetween. Incidentally, in the following description, it is assumed that the meshed metal plate is a meshed stainless steel plate. Further, the perforated or meshed stainless steel plate member and the attenuating filter, such as the ND filter, may manually be put in and out of the space.

The wavelength variable portion 4 is adapted to change the wavelength of light, which is irradiated onto the specimen from the light source 2, by mechanically putting one of plural kinds of interference filters in and out of the space provided between the light source 2 and the specimen. Incidentally, although the wavelength variable portion 4 is set between the light variable portion 3 and the multi-component measurement dry analysis element setting portion 1 in this embodiment, the wavelength variable portion 4 maybe set between the light source 2 and the light variable portion 3. Additionally, the wavelength variable portion 4 may be adapted so that plural kinds of interference filters can manually be put in and out of the space provided therebetween.

The area sensor 6 is a solid-state imaging device, such as a CCD, and operative to receive reflection light obtained from light irradiated from the light source 2 when the reagent set in the reagent supporting portion of the multi-component measurement dry analysis element, which is set in the multi-component measurement dry analysis element setting portion 1, reacts with the specimen, such as blood, and also operative to convert the received light to an electrical signal and to output the electrical signal to the computer 7. The area sensor 6 can receive the light reflected by the reagent supporting portion correspondingly to each of areas thereof. Thus, the measurement of light from areas thereof, which are respectively associated with the reagents, can simultaneously be performed, that is, the measurements respectively associated with plural components can be performed.

The computer 7 is operative to convert an electrical signal, which is outputted from the area sensor 6 and has a level corresponding to the amount of received light, into an optical density value according to data of a calibration curve, which is preliminarily stored in an internal memory, and also operative to obtain the contents of various components, which are contained in the specimen, according to the optical density value and also operative to output the obtained contents of the components to the display or the like. In the case of measuring plural components, the computer 7 extracts electrical signals, whose levels correspond to the amount of received light outputted from the area sensor 6, corresponding to plural areas of the reagent supporting portion, respectively, and obtains the contents of the components contained in the specimen, which are respectively associated with the plural areas. Further, the computer 7 controls the light variable portion 3 and the wavelength variable portion 4 according to the amount of light reflected by the specimen, which is received by the area sensor 6, and to the kinds of the reagents to be reacted with the specimen, in such a way as to change the amount of light irradiated from the light source 2 and the wavelength of this light.

In a case where the amount of light reflected from the specimen is so small to such an extent that this amount is not within the dynamic range of the area sensor 6, in the measuring apparatus 100 of the aforementioned configuration, the meshed stainless steel plate or the ND filter is detached from the space between the light source 2 and the specimen. The light variable portion 3 increases the intensity of light irradiated from the light source 2. Consequently, the amount of light reflected from the specimen is increased in such a way as to be within the dynamic range of the area sensor 6. Thus, even in a case where the dynamic range of the area sensor 6 is narrow, the reflection light can be received with good precision. The accuracy of measurement of the contents of components included in the specimen is enhanced.

Further, in a case where the reagent supporting portion containing, for example, four kinds of reagents A, B, C, and D, the measuring apparatus 100 obtains the amount of light reflected from each of the rears containing the reagents A to D. In a case where one of the amounts of light is not within the dynamic range of the area sensor 6, the light variable portion 3 causes the meshed stainless steel plate member or the ND filter to be inserted and taken out every constant time. Furthermore, because the wavelengths of light rays reflected from the areas differ from one another, the wavelength variable portion 4 changes over the plural interference filters according to the wavelengths.

The flowing description describes, for example, a case where the amounts of light reflected from the areas containing the reagents A and B are so small to the extent that these amounts are not within the dynamic range of the area sensor 6, where the amounts of light reflected from the areas containing the reagents C and D are within the dynamic range of the area sensor 6, and where the wavelengths of light rays, which are outputted when the reagents A to D react with blood, differ from one another.

In this case, in the measuring apparatus 100, the light source 2 irradiates light onto the reagent supporting portion. Light rays reflected from the areas of slides are received by the area sensor 6. The computer 7 decides whether the amount of light reflected from each of the areas is within the dynamic range of the area sensor 6. In this case, the amount of light reflected from each of the areas respectively containing the reagents A and B is small to the extent that this amount of reflected light is not within the dynamic range of the area sensor 6. After light is irradiated for a certain time from the light source 2, the computer 7 controls the light variable portion 3 so that the ND filter is detached from between the light source 2 and the specimen. The light is irradiated for the certain time in this state. Thereafter, the computer 7 controls the light variable portion 3 so that the ND filter is inserted between the light source 2 and the specimen. Such an operation is repeated. Thus, plural kinds of components to be measured can be measured with good accuracy by the single multi-component measurement dry analysis element.

The computer 7, which thus controls the light variable portion 3, also controls the wavelength variable portion 4 according to the kinds of the reagents A to D, simultaneously, so that the wavelength variable portion 4 changes over four kinds of interference filters in turn. During the light variable portion 3 causes the ND filter to be detached, the wavelength variable portion 4 switches the interference filter associated with the reagent A and the interference filter associated with the reagent B to each other. During the light variable portion 3 causes the ND filter to be inserted, the wavelength variable portion 4 switches the interference filter associated with the reagent C and the interference filter associated with the reagent D to each other. Consequently, even in a case where the wavelength of light rays outputted from the plural kinds of components contained in the specimen differ from one another, the contents of the plural kinds of components to be measured, which are contained in the specimen, can be measured by the single multi-component measurement dry analysis element.

Even in the case of using the CCD, whose dynamic range is narrow, the measuring apparatus 100 can achieve high-precision measurement by changing the intensity of light irradiated from the light source 2. However, similarly, the high-precision measurement can be performed by changing the exposure time (the time, during which the reflection light is received) of the CCD under the control of the computer 7 without changing the intensity of light.

Incidentally, although light is irradiated from the light source 2 to the specimen and the contents of components contained in the specimen are found from the light reflected therefrom in this embodiment, the contents of components contained in the specimen maybe found from light transmitted by the specimen.

Further, although the light reflected from the specimen is received by using the area sensor, such as the CCD, in this embodiment, such a light receiving device according to the invention is not limited to the area sensor. A line sensor may be used instead of the area sensor.

Additionally, preferably, the CCD used in this embodiment is a CCD of the honeycomb type, in which light receiving portions, such as photodiodes, are arranged at predetermined intervals lengthwise and breadthwise on a semiconductor substrate, and in which the light receiving portions included in one of each pair of the adjacent light-receiving-portion columns are disposed in such a way as to be shifted from the light receiving portions included in the other adjacent light-receiving-portion column by about half the pitch of the light receiving portions in each of the light-receiving-portion columns in the direction of the light-receiving-portion column.

Although it has been described in the foregoing description that the measuring apparatus 100 changes the intensity of light in real time according to the amount of light reflected from the specimen, each of the contents of the components to be measured may be measured in a preset sequence corresponding to the component to be measured, which is contained in the specimen. Operations in this case are described hereinbelow.

When the reagent supporting portion is set in the multi-component measurement dry analysis element setting portion 1, and the component to be measured is set therein, the measuring apparatus 100 starts measuring this component by using a pattern associated with this component to be measured. First, the computer 7 selects the intensity of light, which is utilized for the measurement, from plural kinds of intensities. Then, light having the selected intensity is irradiated to the specimen. When the area sensor 6 receives reflection light reflected from the specimen, the computer 7 outputs a measurement result according to both the amount of the reflection light received by the area sensor 6 and the selected intensity of light. This sequence of operations enables a good-precision measurement of the component to be measured, which is contained in the specimen.

In the case of changing the exposure time of the CCD without changing the intensity of light, when the reagent supporting portion is set in the multi-component measurement dry analysis element setting portion 1, and the component to be measured is set therein, the measuring apparatus 100 starts measuring this component by using a pattern associated with this component to be measured. First, the computer 7 causes light to be irradiated to the specimen. Then, the area sensor 6 receives reflection light reflected from the specimen for the exposure time selectedby the computer 7. Finally, the computer 7 outputs a measurement result according to both the amount of the reflection light received by the area sensor 6 and the selected intensity of light. This sequence of operations enables good-precision measurement of the component to be measured, which is contained in the specimen.

As described above, the measuring apparatus 100 causes the light source 2 to irradiate light to the reagent supporting portion, and obtains the contents of the component contained in the specimen from resultant reflection light or transmitted light. However, the operation of obtaining the contents by the measuring apparatus 100 is not limited thereto. The measuring apparatus 100 may obtain the contents of the component contained in the specimen by detecting light, such as fluorescence, emitted from the reagent supporting portion when light is irradiated to the reagent supporting portion from the light source 2. Alternatively, the measuring apparatus 100 may the contents of the component contained in the specimen by causing the light variable portion 3 to completely shut out light irradiated from the light source 2 or by inhibiting the use of the light source 2 to thereby establish a state, in which light is not irradiated to the reagent supporting portion at all, and by then detecting light, such as chemiluminescence, emitted from the reagent supporting portion.

Examples according to the invention are described hereinbelow. However, the invention is not limited thereto.

### EXAMLES

### Example of Apparatus

### Configuration of Measuring Apparatus

An optical measurement system, which is optically arranged as shown in FIG. 5, was prepared. Concretely, the following members were prepared.
Optical System: Inverted Stereoscopic Microscope

The following two magnifications were available in the CCD-light-receiving portion:

0.33: 33 μm per pixel in the CCD portion

1:10 μm per pixel in the CCD portion.
Light Source 2: Luminar Ace LA-150UX manufactured by HAYASHI Watch-Works Co., Ltd.
Wavelength Variable Portion (Interference Filters) 4: Filters Monochromatizing to 625 nm, 540 nm, 505 nm, respectively.
Light Variable Portion (Attenuating Filter): Glass Filter ND-25manufactured by HOYA Corporation, and Filter manufactured by the Inventor and by perforating a stainless-steel plate.
Area Sensor (CCD) 6: 8-bit Black-and-White Camera Module XC-7500 manufactured by SONY Corporation
Computer (DataProcessor (ImageProcessor) 7: Image Processor Apparatus LUZEX-SE manufactured by NIRECO Corporation.
Means for Calibrating Reflection Optical Density: Standard Density Plates (Ceramics Specifications) manufactured by FUJI Photo Equipment Co., Ltd. The following six kinds thereof were prepared:
   A00 (Reflection Optical Density: 0 to 0.05);
   A05 (ditto: 0.5);
   A10 (ditto: 1.0);
   A15 (ditto: 1.5);
   A20 (ditto: 2.0); and
   A30 (ditto: 3.0).

### Example 1

A resin tube portion of a 10 mL vacuum blood-collecting tube (whose inside diameter is 13.5 mm) manufactured by TERUMO Corporation was cut off by using a cutter in such a way as to keep the shape of a rubber portion, into which the puncture needle was inserted, unchanged. Then, the puncture needle was inserted into the rubber portion of the cut blood-collecting tube, so that air can enter or exit. In such a state, a piston portion of a syringe manufactured by TERUMO Corporation was inserted thereinto and moved close to a position at a distance of about 10 mm from the rubber portion. Then, the puncture needle was withdrawn. In such a state, the piston portion was pulled by a given distance to thereby decompress the tube. Subsequently, the piston portion was fixed to the tube (1) in such a way as not to move. Then, whole blood preliminarily collected by using lithium heparin as anticoagulant was injected into another syringe manufactured by TERUMO Corporation. Further, a puncture needle was attached to this syringe. Then, this needle was inserted into the rubber portion of the tube (1) to which the piston portion was fixed. An amount of whole blood drawn to the tube (1) by decompression thereof was obtained by a gravimetric method. As is seen from TABLE 1 and FIG. 6, it was found that the amount of whole blood, which corresponded to a reduced volume under decompression, could be collected by pulling the piston portion to thereby decompress the tube. This revealed that whole blood could be introduced to the multi-component measurement dry analysis element by attaching the multi-component measurement dry analysis element to the blood collecting instrument and slidably combining the multi-component measurement dry analysis element with the blood collecting instrument while maintaining a substantially airtight condition, so that an enclosed space was depressurizably defined therein.

TABLE 1
Relation between Immediately Preceding Decompressed
Volume and Amount of Whole Blood Collected by Immediately
Preceding Decompression Method

| | Reduced Volume | |
|---|---|---|
| Piston Pulling | under Decompression | Collected Blood |
| Distance [mm] | [μL] | Amount [μL] |
| 0 | 0 | 0 |
| 5 | 715 | 300 |
| 5 | 715 | 520 |
| 10 | 1430 | 830 |
| 15 | 2150 | 1350 |
| 20 | 2860 | 1950 |
| 25 | 3580 | 2260 |
| 30 | 4290 | 3500 |

### Example 2

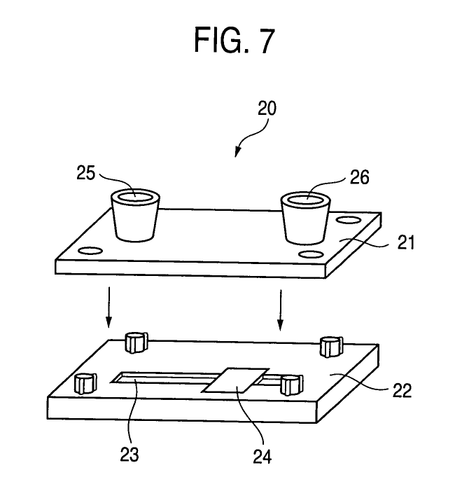

A polystyrene (PS) resin multi-component measurement dry analysis element 20 having a width of about 24 mm and a length of about 28 mm shown in FIG. 7 was prepared. A glassfiber filter paper (GF/D manufactured by Whatman International Ltd.) 27 for trapping red blood cells and for extracting blood plasma, and a polysulfone porous membrane (PSF manufactured by Fuji Photo Film Co., Ltd.) 28 are provided in a flow channel 23, which has a width of 2 mm, a length of 10 mm and a depth of 2 mm, of a lower member 22 of this multi-component measurement dry analysis element 20 so that the polysulfone porous membrane is placed at the side of the color-developing reactive reagent 24. An arrangement portion for the color-developing reactive reagent 24 has a width of 5 mm, a length of 5 mm, and a depth of 2 mm. Each of FUJI DRI-CHEM slide GLU-P (measurement wavelength: 505 nm, measurement component: glucose) or FUJI DRI-CHEM slide TBIL-P (manufactured by Fuji Photo Film Co., Ltd.) serving as the color-developing reactive reagent 24 is cut into a piece, which has a width of 2 mm and a length of 4 mm. Further, these pieces are provided thereon so that the reagent GLU-P is placed above the reagent TBIL-P. Furthermore, the lower member 22 and the upper member 21 are bonded by using a double-sided adhesive tape, so that the airtightness and the watertightness thereof are maintained.

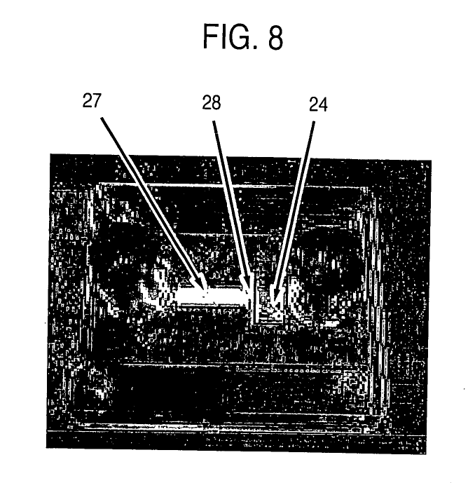

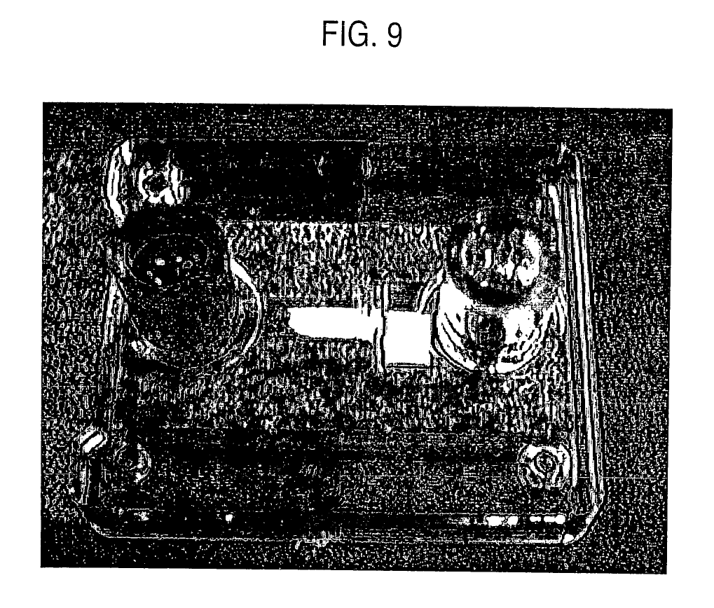

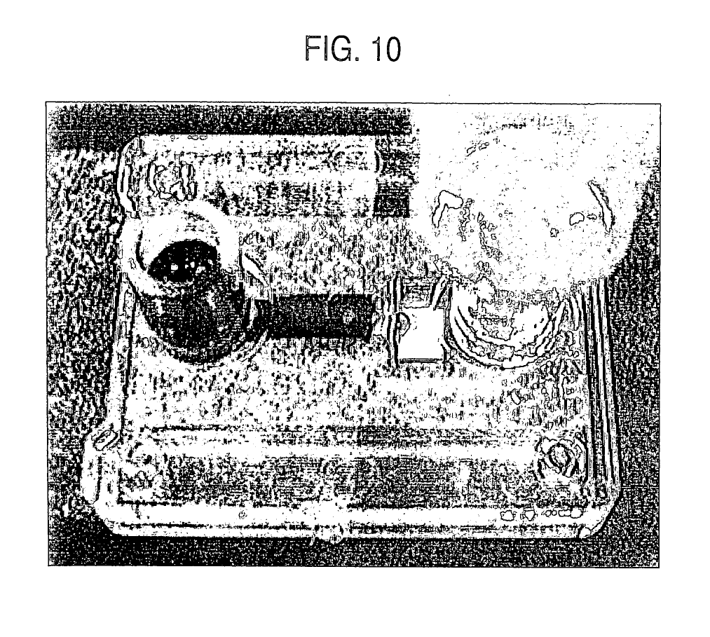

Next, 100 μL of whole blood collected by using a plain tube was inserted into a tube 25 at the side of the glassfiber filter paper 27 of the upper member. Then, the tube 25 was left at rest for a time of 10 seconds to 20 seconds to thereby develop the whole blood in the glassfiber filter paper. Thereafter, a TERUMO syringe was mounted in a tube 26 provided at the side opposite to the glassfiber filter paper side on the upper member. Then, the blood was slightly sucked by this syringe. Blood plasma extracted by filtration leaked from the polysulfone porous membrane 28 and dropped to the slide. Thus, the DRI-CHEM slide GLU-P and the DRI-CHEM slide TBIL-P (hereunder referred to also as GLU-P and TBIL-P slides) gradually started color-development (see FIGS. 8 to 10). Time taken since the injection of the whole blood collected by using the plain tube up to the dropping of the extracted plasma was 30 seconds.

Images showing the color-development of GLU-P and TBIL-P slides were taken by simultaneously using the optical system described in the item [Example of Apparatus] and a CCD camera. Then, the obtained images were processed by using LUZEX-SE. Thus, an average amount of received light at the center of each of the images of the GLU-P and TBIL-P slides was obtained and then converted into the optical density. Consequently, the concentrations of the glucose and the total bilirubin contained in the specimen were obtained. When the image taken by the CCD camera was processed by LUZEX-SE, an amount of received light at the central portion, whose longitudinal size and lateral size were 1 mm and 2 mm, respectively, of each of the images of the GLU-P and TBIL-P slides as calculated by image processing. At that time, a magnification of 0.33 was used as that of the optical system. Thus, the number of pixels in the longitudinal direction was 30, while that of pixels in the lateral direction was 60. That is, a total number of pixels used for the measurement was 1800. To make comparison for deciding whether or not a result obtained by using the CCD camera was correct, the concentrations of glucose and total bilirubin contained in the specimen were obtained by using an automatic clinical test apparatus 7170 manufactured by Hitachi Ltd. TABLE 2 shows results. At that time, the measurement wavelength for GLU-P slide differed from that for TBIL-P slide. Thus, as shown in TABLE 3, the optical measurement was performed by changing the wavelength of the interference filter changed every 5 seconds.

Thus, it was found that the multi-component dry analysis element according to the invention was advantageous in that operations were simple and easy, and could quickly be achieved up to the measurement. In this measurement, reagents for performing dry chemistry on two components were used as the color-developing reactive reagents. However, the number of components to be measured can be increased.

TABLE 2
The Values of Quantities of Components Contained in
Whole Blood and Determined by CCD Detection

| | Values Obtained by CCD | Values Measured by |
|---|---|---|
| | Detection | Hitachi 7170 |
| | [mg/dL] | [mg/dL] |
| Glucose | 95 | 99 |
| Total | 0.48 | 0.44 |
| Bilirubin | | |

TABLE 3
Sequence of Irradiations Performed by Serially Changing
Wavelength and Amount of Light

| Order No. | Wavelength [nm] |
|---|---|
| 1 | 505 |
| 2 | 540 |

The wavelength to be used was serially and alternately changed between the wavelengths, which were respectively associated with the order numbers 1 and 2, in this order.

### Example 3

### Measurement Using Density Plates

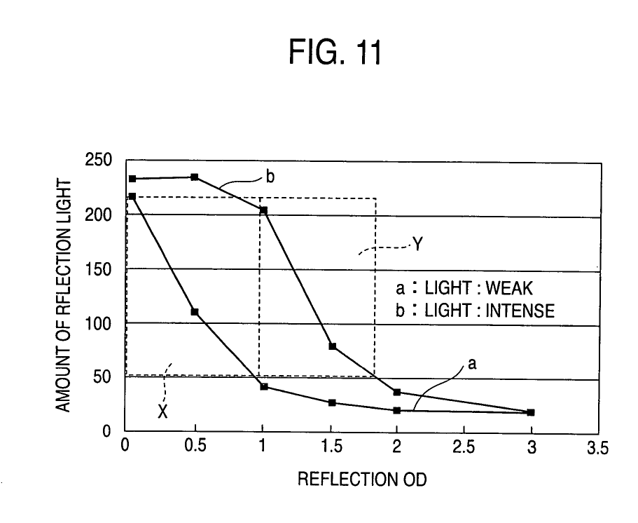

The relation between the optical density and the amount of received reflection light was obtained by using light monochromatizedto 625 nm. A region of the mount of the received light, which could be measured by the 8-bit black-and-white CCD with good accuracy, was set to be a range of a calibration curve. Thus, the optical density was obtained as follows.
(1) The amount of light irradiated from the light source was adjusted by using the standard density plate, whose optical density was substantially 0, and inserting the attenuating filter so that the amount of light received by this standard density plate was about 200. Then, the relation between the optical density and the amount of received reflection light was obtained by using the six kinds of standard density plates. Thus, the calibration curve was formed. When the perforated stainless-steel plate was used as the attenuating filter, the amount of light irradiated onto the sample part was 96 μW/cm².
(2) The state of the optical system described in this item (1) was kept unchanged, except that only the attenuating filter was removed. Then, the relation between the optical density and the amount of received reflection light was obtained by using the six kinds of standard density plates. Thus, the calibration curve was formed. When the perforated stainless-steel plate used as the attenuating filter was removed, the amount of light irradiated onto the sample part was 492 μW/cm².
(3) A region, in which the amount of received reflection light measured on the conditions described in the item (1) was less than 50 (the reflection optical density ranges from 0 to 0.9 as shown in FIG. 11), was set to be Region X, while a region, in which the amount of received reflection light measured on the conditions described in the item (2) was less than 50, and from which a part overlapping with the Region X was removed (that is, the region, in which the reflection optical density ranged from 0. 9 to 1.8 as shown in FIG. 11), was set to be Region Y.
(4) In the range of the Region X, the calibration curve a obtained by performing the measurement on the conditions described in the item (1) was used. In the range of the Region Y, the calibration curve b obtained by performing the measurement on the conditions described in the item (2) was used. Then, the reflection optical density of a sample (to be described later) was measured.

Subsequently, the measurement was performed by photometry using the standard density plates on the condition that N=10. Thus, the standard deviation of the reflection optical density was obtained. In the case where the density plate A05, whose optical density was small, was used, the measurement was performed in the region X. Thus, the attenuating filter was used on the conditions described in the item (1). In the case where the density plates A10 or A15, whose optical density was large, was used, the measurement was performed in the region Y. Thus, the attenuating filter was detached, and the measurement was conducted on the conditions described in the item (2). Consequently, in each of the cases respectively using the density plates A05, A10, and A15, it was achieved that the standard deviation of the reflection optical density (SD of OD) was not more than 10/10000. Thus, the measurement was achieved with good precision. The magnification of the optical system used for the measurement was 0.33. The amount of received light was calculated by performing image processing on the 5-m-diameter central portion of the image of each of the standard density plates, which was taken by the CCD camera. The central portion was a circle whose radius included 75 pixels. Thus, the measurement was performed on the portion including pixels, the number of which was 17662. Incidentally, a total time needed for the measurement, which was a sum of a time needed for the optical measurement and a time needed for the image processing, was 1 second.

An experiment for enhancing accuracy, with which the quantization was simultaneously performed on plural components by using the plural interference filters, were conducted by using the optical system shown in FIG. 5. In this experiment, each of test pieces of dry clinical test reagents for use in FUJI DRI-CHEM slide GLU-P (measurement wavelength: 505 nm, measurement component: glucose) or FUJI DRI-CHEM slide TBIL-P (measurement wavelength: 540 nm, measurement component: total bilirubin) manufactured by Fuji Photo Film Co., Ltd., was cut out so that the size thereof was about 2 mm×4 mm. Each of such test pieces was provided in a transparent resin cell whose size was 5 mm×5 mm. Then, 4 μL of each of control serums (of the two kinds L and H), the contents of the components thereof were known, was dropped to the test piece from above. At room temperature, the components to be measured, which were contained in the serum, were reacted with the reagents to thereby perform the color development.

At that time, to calibrate the reflection optical density obtained from the component to be measured, calibration materials obtained by solidly exposing and developing sheets of black-and-white photographic paper stepwise were cut t into four pieces (respectively corresponding to Level 1 to Level 4), the size of each of which was about 1.5 mm×2mm. Subsequently, these calibration material pieces were arranged together with the two test pieces in the same field of view (that is, the imageable range of the CCD). Then, the image of these pieces was taken by the CCD using light that was monochromatized by the interference filter. In this case, the computer 7 receives reflection light from the calibration material, together with reflection light from other specimens, and performs an operation of correcting the optical densities of the other components contained in the specimen. Incidentally, in this experiment, the amount and the wavelength of light irradiated onto the slides were serially changed in the order described in TABLE 4 listed below. The reflection optical density of the calibration material was set at values described in TABLE 5.

TABLE 4
Sequence of Irradiations Performed by Serially Changing
Wavelength and Amount of Light

| Order No. | Wavelength [nm] | Attenuating Filter |
|---|---|---|
| 1 | 505 | Inserted |
| 2 | 505 | Detached |
| 3 | 540 | Inserted |
| 4 | 540 | Detached |

The wavelength to be used was serially changed between the wavelengths, which were respectively associated with the order numbers 1, 2, 3 and 4, in this order.

TABLE 5
Optical Densities of Solidly Printed Black-and-White
Photographic Paper for Correcting Reflection Density

| | Reflection Optical Densities at Wavelengths | | | |
|---|---|---|---|---|
| Wavelength [nm] | LEVEL 1 | LEVEL 2 | LEVEL 3 | LEVEL 4 |
| 505 | 0.0620 | 0.9219 | 1.3941 | 1.6858 |
| 540 | 0.0677 | 0.9155 | 1.3968 | 1.6768 |

The reflection optical densities were obtained by using MCPD-2000 manufactured by OTSUKA ELECTRONICS CO., Ltd.

Regarding the components to be measured, the amount of reflection light received by the CCD when light rays respectively having the wavelengths of 505 nm and 540 nm ranged from 50 to 200 in a state in which the attenuating filter was inserted, the reflection optical densities were obtained from the amount of the reflection light rays by using the calibration curve a shown in FIG. 11. Regarding the components to be measured, the amount of reflection light was less than 50, the reflection optical densities were obtained from the amount of the reflection light received by the CCD in a state in which the attenuating filter was detached, were obtained by using the calibration curve b shown in FIG. 11. The concentrations of glucose and total bilirubin were calculated from the reflection optical densities thereof, which were obtained when glucose and total bilirubin perform the color-development, and from data of the calibration curves, which were preliminarily stored in the computer 7 and represent the corresponding relation between the reflection optical density and the content of the component to be measured. Results of the calculation are shown in TABLE 6 listed below.

TABLE 6
Concentrations of Measured Components in Blood Serum
[mg/dL]

| | |
|---|---|
| Control Serum L | Control Serum H |

| | | Control | | Control |
|---|---|---|---|---|
| | Actual | Serum | Actual | Serum |
| | Measurement | Standard | Measurement | Standard |
| | Value | Value | Value | Value |
| Glucose | 107 | 108.4 | 312 | 319.0 |
| Total | 1.01 | 1.07 | 5.36 | 5.49 |
| Bilirubin | | | | |

As shown in TABLE 6, each of the actual measurement values was nearly equal to the associated control serum standard value. Thus, it was prove that even when the CCD having a narrow dynamic range was used, the measurement of the contents of the measured components of the blood serum could be achieved with good accuracy. Further, according to this example, two components to be measured were simultaneously measured. Thus, as compared with the conventional case where two slides GLU-P and TBIL-P were separately measured, this example could efficiently perform the measurement. Although only two components to be measured were measured in this example, the measurement of the concentrations of two or more components to be measured could simultaneously achieved, as long as the components were placed within the imageable range of the CCD.

[Study on The Number of Pixels]

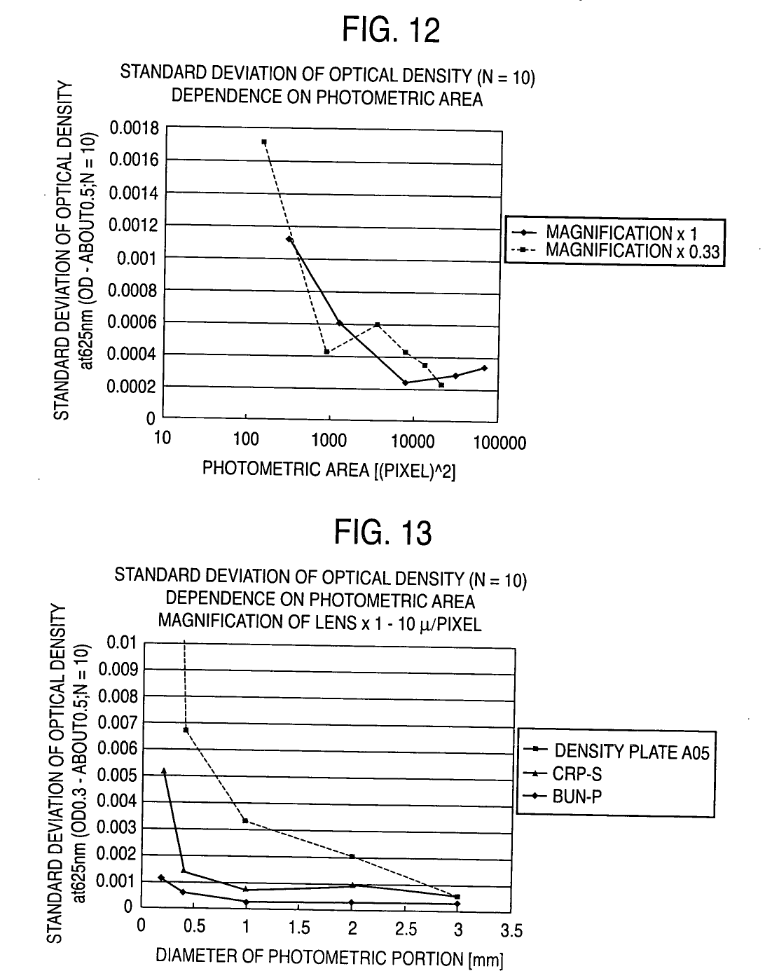

The optical image of the standard density plate A05 was taken by the optical system using light monochromatized to 625 nm on condition that N=10. Further, the standard deviation of the reflection optical density of the density plate. The reflection optical densities were calculated by changing the zone in the vicinity of the center of the imaged density plate when the reflection optical density was obtained. Thus, the dependence of the standard deviation of the reflection optical density upon a photometric area was obtained. Results are shown in TABLE 7, TABLE 8, and FIG. 12.

The photometric actual dimension size differed from a pixel area obtained by the CCD according to the magnification of the lens. In a case where the number of pixels representing the measured area was not less than 1000, the standard deviation of the optical density become not more than 10/10000. Thus, the measurement could be performed with good accuracy. Incidentally, the “pixel” referred herein is a picture element. Similarly, the “number of pixels” means the number of picture elements.

TABLE 7
Dependence of Standard Deviation of Optical Density
on Photometric Area (Magnification: x1 corresponding to 10
μm/pixel)

| | | | | | |
|---|---|---|---|---|---|
| Photometric Diameter [mm] | 0.2 | 0.4 | 1 | 2 | 3 |
| Photometric Diameter [px] | 20 | 40 | 100 | 200 | 300 |
| Photometric Area [px²] | 314 | 1256 | 7850 | 31400 | 70650 |
| SD of OD [x1/10000] | 11.2 | 6.1 | 2.4 | 2.9 | 3.4 |

TABLE 8
Dependence of Standard Deviation of Optical Density
on Photometric Area (Magnification: xO.33 corresponding to 33
μm/pixel)

| | | | | | | |
|---|---|---|---|---|---|---|
| Photometric | 0.4 | 1 | 2 | 3 | 4 | 5 |
| Diameter [mm] | | | | | | |
| Photometric | 14 | 34 | 67 | 100 | 133 | 167 |
| Diameter [px] | | | | | | |
| Photometric Area | 154 | 907 | 3524 | 7850 | 13886 | 21631 |
| [px²] | | | | | | |
| SD of OD | 17.1 | 4.2 | 5.9 | 4.3 | 3.5 | 2.3 |
| [x1/10000] | | | | | | |

### Example 4

It was considered that in a case where a dry multilayer film was used as the color-developing reaction reagent of the multi-component measurement dry analysis element, the surface roughness of the photometric surface of the multilayer film affected the amount of reflection light. The simultaneous repeatability of the reflection optical density was measured by using multilayer films, which differed in the surface roughness from one another, and changing the photometric size. For comparison, that of the reflection optical density was similarly measured on a ceramic standard density plate, whose surface was smooth and flat. As the multilayer film having a large surface roughness, FUJI DRI-CHEM slide CRP-S manufactured by Fuji Photo Film Co., Ltd., was used. As the multilayer film having a small surface roughness, FUJI DRI-CHEM slide BUN-P manufacturedby Fuji Photo Film Co., Ltd., was used. In the case of CRP-S, the reflection surface used for reflection-photometry had a large roughness due to the texture of a cloth applied to the side opposite to the photometric surface. In the case of BUN-P, the reflection surface used for reflection-photometry had a small roughness, because a porous membrane was stuck to an intermediate layer. Incidentally, the standard density plate A05 (whose reflection optical density was 0.5) manufactured by FUJI Photo Equipment Co., Ltd., was used as the ceramic standard density plate.

Additionally, the optical system, which was the same as shown in FIG. 5) was used. The magnification used by the CCD light receiving portion was 1 (in the CCD portion, 10 μm/pixel).

The reflection optical density was measured 10 times by changing the photometric diameter of the portion to be measured from 0.2 mm to 3 mm. The standard deviations of the reflection optical densities in this case were shown in TABLE 9 and FIG. 13. It was found that when the photometric diameter was 3 mm, the standard deviation was not more than 10/10000 and thus could be measured with good accuracy in the case of any multilayer film. When the photometric diameter was decreased, the standard deviation was increased. In the case of CRP-S, when the photometric diameter was 1 mm, the standard deviation exceeded 10/10000. Conversely, in the case of BUN-P using the porous membrane, even when the photometric diameter was 1 mm, the standard deviation was not more than 10/10000. It was found that in the case of using a porous membrane, the surface roughness of the reflection surface used for reflection-photometry could be decreased, and that the measurement was achieved with higher accuracy. Further, in the case of the measurement using the standard density plate A05 whose surface roughness was extremely small, when the photometric diameter 0.2 mm, the number of pixels of the surface having undergone photometry was less than 1000. The standard deviation exceeded 10/10000. However, when the photometric diameter was 1 mm, the standard deviation was 2.4/10000. Thus, it was found that the use of the porous membrane or fine particles rather than that of the cloth practically used in FUJI DRI-CHEM slide CRP-S could effectively reduce the surface roughness of the reflection surface used for reflection-photometry, and that this was a key factor in enhancing the measurement accuracy.

TABLE 9
Dependence of Standard Deviation (N = 10) of Optical
Density on Photometric Area [x1/10000]

| | | | | | |
|---|---|---|---|---|---|
| Photometric Diameter [mm] | 0.2 | 0.4 | 1 | 2 | 3 |
| Pixel Diameter [px] | 20 | 40 | 100 | 200 | 300 |
| Photometric Area [px²] | 314 | 1256 | 7850 | 31400 | 70650 |
| CRP-S | 330.5 | 67.3 | 32.7 | 20.0 | 5.3 |
| BUN-P | 51.6 | 14.2 | 7.9 | 9.7 | 5.6 |
| Standard Density Plate A05 | 11.2 | 6.1 | 2.4 | 2.9 | 3.4 |

### Example 5

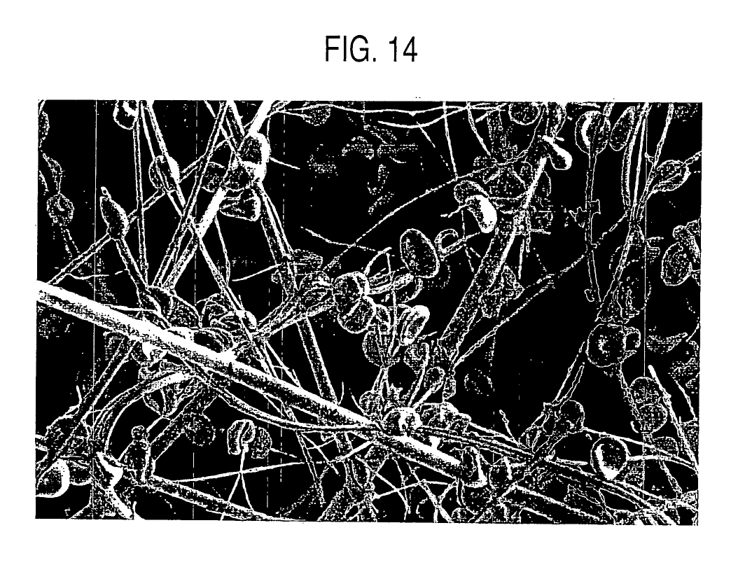

It was observed how red blood cells of whole blood were trapped by glassfibers that are of one of kinds of fibers used as the filter member in the multi-component measurement dry analysis element. Whole blood was collected from a healthy male by using a vacuum blood collecting tube employing lithium heparin as anticoagulant. At that time, Hct value was 45%. At room temperature, 10 μL of this whole blood was dropped to the glassfiber filter paper GF/D (the diameter of the glassfiber was not more than about 3 pm) manufactured by Whatman International Ltd. Then, the glassfiber filter paper, to which the whole blood was dropped, was immediately put into 0.1 mol/L of a phosphate buffer solution (pH 7.4) containing 1 % of glutaraldehyde. Then, the filter paper was left at rest for 2 hours at room temperature. Thus, the red blood cells were hardened. Then, the ratio of water to t-butanol of the mixture was gradually changed. Finally, the mixture was replaced with a t-butanol solution. This t-butanol solution was left at rest in a refrigerator for about 1 hour to thereby freeze the t-butanol solution. Subsequently, a solvent was removed by bringing the frozen t-butanol solution containing the glassfiber filter paper into a freeze dryer. The obtained dry glassfiber filter paper, to which whole blood was dropped, was observed by a scanning microscope. Thus, a photograph, whose magnification was 1000, was obtained. FIG. 14 shows this photograph. In the photograph shown in FIG. 14, the width thereof was 120 μm at full scale. It was found that the red blood cells were trapped by the glassfibers, whose diameters were not more than about 3 μm.

For comparison, similar experiments were conducted by using a glassfiber filter paper employing glassfibers, whose diameters were 8 μm, and another glassfiber filter paper employing glassfibers, whose diameters were about 10 μm, and an accetylcellulose fiber employing accetylcellulose fibers, whose diameters were about 15 μm. Consequently, it was found that the glassfibers, whose diameters were 8 μm, could not fully trap red blood cells, and that the glassfibers, whose diameters were 15 μm, and the accetylcellulose fibers, whose diameters were about 15 μm, could not trap red blood cells at all.

This revealed that in the case of using whole blood as a specimen, red blood cells could quickly and efficiently be removed by using fibers, which had specific equivalent circle diameters, that is, water-insoluble substances as the filter element of the multi-component measurement dry analysis element. Moreover, according to the invention, it was unnecessary for removing red blood cells from whole blood to operate a special apparatus. Thus, it was found that blood plasma could quickly be supplied to a reagent, and that the time required to perform operations up to the measurement could be reduced.

### INDUSTRIAL APPLICABILITY

According to the invention, there is provided an analysis element for use in a blood test method enabled so that operations are easy and simple to perform, and that the operations are performed quickly up to the detection of a component. Also, there is provided an analysis element for use in a blood test method enabled so that operations up to the detection of a component is quickly performed for many components, and that the blood test method is safe and has the measurement accuracy thereof is sufficient.

Furthermore, according to the invention, there is provided an analysis element for use in a test method using body fluids and urines of humans and animals, and also using plain water, seawater, soil extract, agricultural products, marine products, processed-food extracts, and liquid for use in scientific research as specimens.

1. A multi-component measurement dry analysis element for use in a method for testing a specimen, the method using an area sensor as a detector to obtain a result of measurement according to information of 1000 pixels or more per one component and to perform simultaneous measurements of plural components.

2. The multi-component measurement dry analysis element according to claim 1, which comprises a flow channel, a color-developing reactive reagent and a portion supporting said color-developing reactive reagent,
wherein at least one of a width, a depth, and a length of the flow channel is not less than 1 mm, and
wherein a width of the portion supporting the color-developing reactive reagent is not less than twice the width of the flow channel, and/or, a length of the portion supporting the color-developing reactive reagent is not less than 0.4 times the length of the flow channel.

3. The multi-component measurement dry analysis element according to claim 2, which comprises a filtering portion containing a water-insoluble substance that has an equivalent circle diameter of not more than 5, μm and a length equal to or longer than an equivalent circle radius.

4. The multi-component measurement dry analysis element according to claim 2, which comprises a filtering portion containing fibers having an equivalent circle diameter of not more than 5 μm.

5. The multi-component measurement dry analysis element according to claim 2, which comprises a filtering portion containing: fibers having an equivalent circle diameters of not more than 5 μm; and a porous membrane.

6. The multi-component measurement dry analysis element according to claim 2, which comprises a filtering portion containing: glass fibers having an equivalent circle diameters of not more than 5 μm; and a porous membrane.

7. The multi-component measurement dry analysis element according to claim 2, which comprises a dry multilayer film as a reagent layer in the portion supporting the color-developing reactive reagent.

8. The multi-component measurement dry analysis element according to claim 2, which comprises a dry multilayer film, to which a porous membrane is adhered, as a reagent layer in the portion supporting the color-developing reactive reagent.

9. The multi-component measurement dry analysis element according to claim 2, which comprise a dry multilayer film, to which fine particles having a diameter of not more than 100 μm, are adhered, as a reagent layer in the portion supporting the color-developing reactive reagent.

10. The multi-component measurement dry analysis element according to claim 2, wherein the portion supporting the color-developing reactive reagent is a cell connected to the flow channel.

11. The multi-component measurement dry analysis element according to claim 2, which comprises a dry multilayer film as a reagent layer of the portion supporting the color-developing reactive reagent, wherein a specimen is supplied to a reagent through a polymer porous element.

12. The multi-component measurement dry analysis element according to claim 2, which comprises a dry multilayer film as a reagent layer of the portion supporting the color-developing reactive reagent, wherein a specimen is supplied to a reagent through a space formed by engraving the flow channel itself.

13. A multi-component measurement dry analysis element for use in a method for testing a specimen, the method using a line sensor as a detector to perform simultaneous measurements of plural components, wherein the multi-component measurement dry analysis element comprises: a flow channel; a color-developing reactive reagent; a portion supporting the color-developing reactive reagent; and a filtering portion containing a water-insoluble substance that has an equivalent circle diameter of not more than 5 μm and a length equal to or longer than an equivalent circle radius,
wherein at least one of a width, a depth and a length of the flow channel is not less than 1 mm, and
wherein a width of the portion supporting the color-developing reactive reagent is not less than twice the width of said flow channel, and/or, a length of the portion supporting the color-developing reactive reagent is not less than 0.4 times the length of the flow channel.

14. A multi-component measurement dry analysis element for use in a method for testing a specimen, the method using an electrochemical sensor as a detector to perform simultaneous measurements of plural components, wherein the multi-component measurement dry analysis element comprises: a flow channel; a reactive reagent; a portion supporting the reactive reagent; and a filtering portion containing a water-insoluble substance that has an equivalent circle diameter of not more than 5 μm and a length equal to or longer than an equivalent circle radius,
wherein at least one of a width, a depth and a length of the flow channel is not less than 1 mm.

15. A blood collection unit comprising:
the multi-component measurement dry analysis element according to claim 2; and
a blood collecting instrument containing at least two portions capable of sliding from each other while maintaining substantially airtight state,
wherein the blood collecting instrument houses the multi-component measurement dry analysis element, and the at least two portions are slidably combined to form an enclosed space therein capable of being depressurized.

16. The blood collection unit according to claim 15, wherein the blood collecting instrument has a puncture needle having a diameter of not more than 100 μm and having a needle tip angle of not more than 20°.

17. A blood collection unit comprising:
the multi-component measurement dry analysis element according to claim 13; and
a blood collecting instrument containing at least two portions capable of sliding from each other while maintaining substantially airtight state,
wherein the blood collecting instrument houses the multi-component measurement dry analysis element, and the at least two portions are slidably combined to form an enclosed space therein capable of being depressurized.

18. The blood collection unit according to claim 17, wherein the blood collecting instrument has a puncture needle having a diameter of not more than 100 μm and having a needle tip angle of not more than 20°.

19. The multi-component measurement dry analysis element according to claim 2, wherein the specimen is a liquid for use in tests of environment-related materials.

20. The multi-component measurement dry analysis element according to claim 2, wherein the specimen is a liquid for use in tests of agricultural products, marine products, or foods.

21. The multi-component measurement dry analysis element according to claim 2, wherein the specimen is a liquid for use in scientific research.
